(19) United States
(12) Patent Application Publication
(10) Pub. No.: US 2017/0322587 A1
(43) Pub. Date: Nov. 9, 2017

(54) METHOD FOR SCHEDULING AN AUDIO TREATMENT OF A MOTOR VEHICLE, AND ASSOCIATED OPERATING SYSTEM

(71) Applicant: ARKAMYS, PARIS (FR)

(72) Inventor: YVAN BOURMEYSTER, PARIS (FR)

(21) Appl. No.: 15/535,035

(22) PCT Filed: Dec. 11, 2015
(86) PCT No.: PCT/EP2015/079439

§ 371 Date: Jun. 9, 2017

(30) Foreign Application Priority Data
Dec. 16, 2014 (FR) 1462544

(51) Int. Cl. G06F 1/12; G06F 13/42; G06F 3/16

(52) U.S. Cl. CPC G06F 1/12; G06F 3/165; G06F 13/4217

(57) ABSTRACT

A scheduling method for an audio treatment of a motor vehicle includes elementary functions having inputs and outputs and a sampling frequency generated by a master clock. Inputs and outputs have a frame rate and a sampling frequency generated by the master clock. The elementary functions, the master clocks of which are synchronous, are grouped into synchronicity domains. A maximum treatment time is calculated which corresponds to the time necessary both to treat all the input and output frames by the elementary functions given that the inputs and outputs are produced sequentially, and also to return the elementary functions to their initial states. A scheduling of the elementary functions of each synchronicity domain is determined as a function of the maximum treatment time.

### FIELD OF THE INVENTION

The present invention relates to a method for scheduling audio processing of a motor vehicle, and also the associated operating system.

The invention has a particularly advantageous application for motor vehicles comprising a very rich and varied audio architecture.

### PRIOR ART

Motor vehicles integrate more and more audio streams originating from different sources and intended for different peripheral devices. For example, a motor vehicle may comprise means for processing and reading audio streams originating from a CD player, an MP3 player, a car radio, an integrated GPS and a Bluetooth input. These audio streams may be played on two front loudspeakers, a central unit, two rear loudspeakers and/or a hands-free kit for the driver.

A digital signal processor is conventionally implemented to process the different audio streams. A digital signal processor (also referred to as DSP in the literature) is a microprocessor optimized to run the applications for the digital processing of the signal (filtering, signal extraction, etc.) as quickly as possible.

Since the emergence of open systems, the increase in the performance of the processors and the virtualization capacities of these processors, some audio processing operations are performed on a main processor of the vehicle. For example, motor vehicles generally comprise a dedicated processor for the management of the CAN (motor vehicle bus) managing the vital functions of the motor vehicle and capable of simulating the use of a digital signal processor.

Audio processing operations are programmed on the main processor in the form of elementary functions by analogy with the audio processing operations previously performed physically by the digital signal processor(s). Each elementary function comprises at least one input or at least one output and a sample rate generated by a master clock. A “master clock” represents a low-level hardware clock (also referred to as hardware in the literature) allowing one or more sample rates to be generated. The main processor is also connected to a plurality of inputs and outputs, each input/output comprising a frame size and a sample rate generated by a master clock.

The implementation of these elementary functions by the main processor is performed as a function of the requirements of the inputs or outputs by a specific scheduling. Scheduling theory is a branch of operational research which focuses on the calculation of optimum task performance dates. To do this, it is very often necessary to allocate simultaneously the resources necessary for the performance of these tasks. A scheduling problem may be considered as a planning sub-problem in which the performance of the planned tasks must be decided.

In the prior art systems, the scheduling of the tasks of the processor is therefore brought about as a function of the requirements of the inputs or outputs of the audio architecture of the motor vehicle. When an input arrives, it is processed both by the main processor and on a digital signal processor.

However, this scheduling of the elementary functions does not enable effective processing of the incoming audio streams which are normally delayed in relation to one another. For example, when Bluetooth is activated to play a voice call to the driver and other audio streams are processed at the same time, some audio streams are subject to delays due to the difference of occurrence of the audio streams and the difference between the master clocks of the different inputs.

### EXPLANATION OF THE INVENTION

The present invention aims to overcome the disadvantages of the prior art by proposing a method for scheduling an audio processing of a driven motor vehicle as a function of a simulation of a particularly unfavorable case in which all the input/outputs are used.

For this purpose, according to a first aspect, the invention relates to a method for scheduling an audio processing of a motor vehicle, said audio processing comprising a plurality of elementary functions implemented by a microprocessor, each elementary function comprising at least one input or at least one output and a sample rate generated by a master clock, and a plurality of inputs and outputs, each input/output comprising a frame size and a sample rate generated by a master clock, the method comprising the following steps: grouping, into synchronicity domains, the elementary functions, the master clocks of which are synchronous, calculating a maximum processing time corresponding to the time required, on the one hand, to process all the frames of the inputs by means of the elementary functions when the inputs/outputs are produced sequentially, and, on the other hand, so that the elementary functions return to their initial states, and determining a scheduling of the elementary functions of each synchronicity domain as a function of the maximum processing time.

The invention effectively reduces delays, thus improving the responsiveness of the system and enabling compliance with the responsiveness standards imposed by certain countries, including France. The invention also reduces the development time and installation time of audio systems.

According to one embodiment, the method also includes a step consisting in interconnecting the synchronicity domains by means of asynchronous sample-rate converters.

According to one embodiment, only the scheduling of the inputs/outputs is stored. The scheduling of the elementary functions is obtained in a unique and reproducible manner due to the scheduling of the input/outputs and relative priorities allocated to each of the elementary functions. The invention thus provides a descriptive graph controlled by the service compared to a descriptive graph produced by the occurrence of the input/outputs.

According to one embodiment, the descriptive graph is stored in a reconfigurable file. The audio architecture of the vehicle is then more flexible in terms of structural modification and updating.

According to a second aspect, the invention relates to an operating system comprising a framework comprising means for grouping, into synchronicity domains, the elementary functions, the master clocks of which are synchronous, calculating a maximum processing time corresponding to the time necessary, on the one hand, to process frames of the inputs by means of the elementary functions when inputs/outputs are produced sequentially, and, on the other hand, so that the elementary functions return to an initial state, and determining a scheduling of the elementary functions of each synchronicity domain as a function of the maximum processing time.

According to one embodiment, the system comprises a file containing a descriptive graph of a scheduling of the elementary functions, a service capable of interpreting said descriptive graph as a function of the inputs and outputs, and structural components controlled by said service and capable of performing audio processing operations.

According to one embodiment, the system comprises means for anticipated starting of the service during the starting of the system. This embodiment improves the responsiveness of the audio system during the starting process.

### BRIEF DESCRIPTION OF THE DRAWINGS

The invention will be better understood from the description, given below for purely explanatory purposes, of the embodiment of the invention, with reference to the figures, in which:

FIG. 1 shows a structural representation of an operating system implementing the scheduling method according to one embodiment of the invention;

FIG. 2 shows a structural representation of the framework shown in FIG. 1; and

FIG. 3 shows a schematic representation of a scheduling method according to one embodiment of the invention

### DETAILED DESCRIPTION OF THE EMBODIMENTS OF THE INVENTION

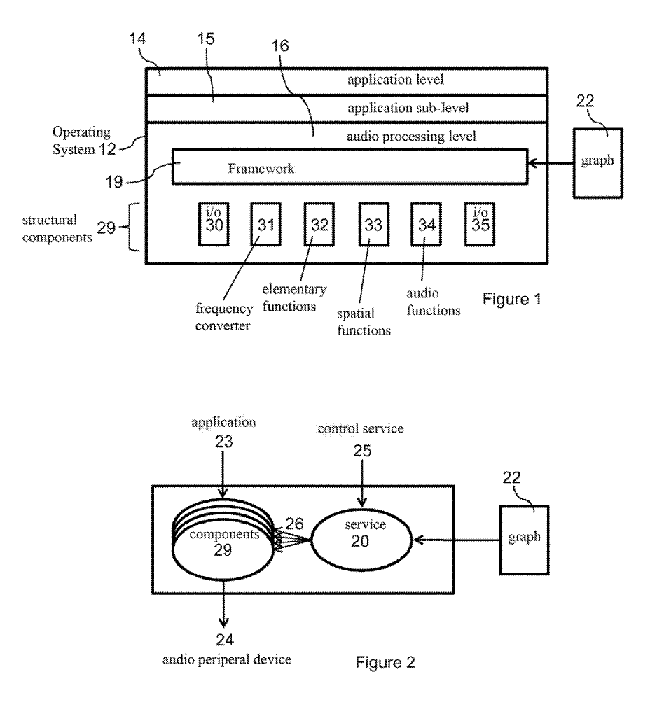

FIGS. 1 to 3 show a method 10 for scheduling an audio processing of a motor vehicle including a plurality of audio functionalities integrated into an operating system 12 in the form of elementary functions 32. The invention can be installed on all enhanced operating systems such as Linux or Android. For example, the operating system 12 may run on an ARM (registered trademark) or Cortex (registered trademark) processor. The operating system 12 includes an application level 14 then a multimedia application sub-level 15 and finally an audio processing sub-level 16 integrating the audio processing according to the invention.

This audio processing level 16 includes a framework 19 grouping a set of structural components 29. In computer programming, a framework is a coherent set of structural software components which serves to create the foundations and outlines of all or part of a software package (architecture). This framework 19 is represented in FIG. 2 by a service 20 (commonly referred to as a “daemon” in the literature) transmitting control signals 26 to the structural components 29. The service 20 is controlled by the operating system 12 via a control service 25 and its behavior is dictated by a descriptive graph 22.

The structural components 29 process the data of the application 23 until these data are transmitted to an audio peripheral device 24 in order to play them. The structural components 29 include two input/output modules 30, 35. The input signals may originate from a Bluetooth peripheral device, from a home automation player module, from a multimedia music player, from a microphone, from a CD player or a DVD player, etc. The output signals may be transmitted to a Bluetooth-connected peripheral device, to one or more loudspeakers or to a peripheral device connected to a high-definition multimedia interface, etc. Its inputs and its outputs have frame sizes and sample rates which may be different. Furthermore, the sample rates of each input/output are generated by a master clock which may vary between a plurality of inputs/outputs. A “master clock” represents a low-level hardware clock (or hardware in the literature).

The structural components 29 also include a software and/or hardware frequency converter 31. The audio processing operations are performed by elementary functions 32 and/or sound spatialization functions 33 inside the vehicle and/or functions 34 integrating advanced audio effects. The functions 32-33 generally come into play at an advanced stage of the audio processing chain, whereas the elementary functions 32 come into play at the beginning of the audio processing chain. The elementary functions 32 group highly diverse processing operations such as amplifiers, filters, multiplexers, demultiplexers, dephasers, equalizers, limiters, etc. Its functions are thus structurally highly heterogeneous since some require one input signal and supply one output signal while others require two input signals and supply one output signal and others again require one input signal and supply two output signals. Moreover, its functions use different input and output frame sizes and different sample rates. The sample rates of each structural component 29 are furthermore generated by a master clock which may vary between a plurality of structural components 29.

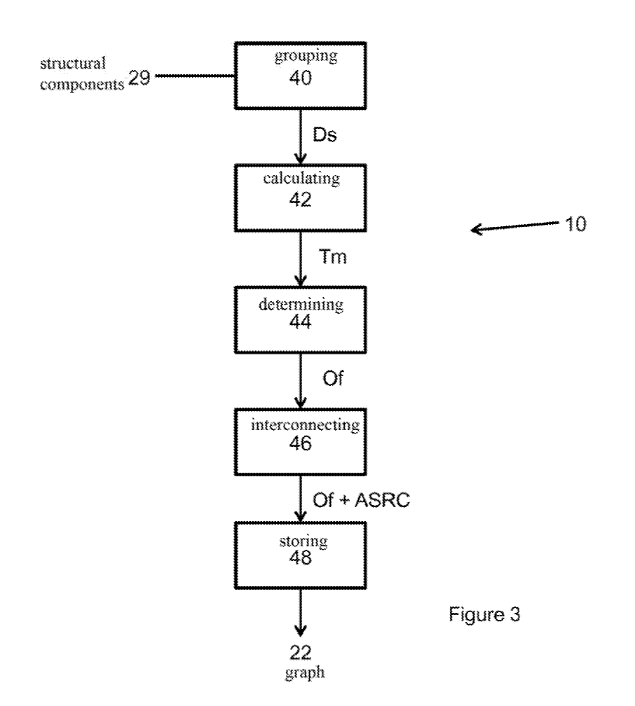

The scheduling method 10 of the invention shown in FIG. 3 defines the descriptive graph 22 as a function of the characteristics of the implemented structural components 29. Scheduling theory is a branch of operational research which focuses on the calculation of optimum task performance dates. To do this, it is very often necessary to allocate simultaneously the resources necessary for the performance of these tasks. A scheduling problem may be considered as a planning sub-problem in which the performance of the planned tasks must be decided.

The scheduling method 10 comprises a first step consisting in grouping 40 the elementary functions 32, the master clocks of which are synchronous, into synchronicity domains Ds. Two or three synchronicity domains generally exist, but this may vary as a function of the installed elementary functions 32. A second step consists in calculating 42 a maximum processing time Tm. For this step, the activity of the inputs/outputs of 30, 35 is simulated for an ideal case in which the inputs/outputs are produced sequentially. The processing time of the inputs/outputs is determined as a function of the sample rate and the frame size of each input/output. This processing of the inputs/outputs is performed until the maximum processing time Tm so that the elementary functions 32 return to their initial state.

A following step consists in determining 44 a scheduling Of of the elementary functions 32 of each synchronicity domain Ds as a function of the maximum processing time Tm. The scheduling of the elementary functions of a synchronicity domain is made unique and always reproducible. It is obtained through the coexistence of the following elements: the sequencing of the inputs/outputs in the time Tm; the relative priorities given to each elementary function 32; the availability of the input data of the elementary functions 32; and the facility to remove the output data of the elementary functions 32. The status of the availability of the input and of the facility to remove output data is cyclical in such a way that all elementary functions have the same initial state. This cycle is a multiple of the time Tm.

A following step consists in interconnecting 46 the synchronicity domains Ds via asynchronous sample-rate converters (ASRC in the literature). The final step consists in storing 48 the scheduling Of of the inputs/outputs and the relative priorities between the elementary functions 32 so that the scheduling can control the actions of the service 20. The descriptive graph 22 is preferably stored in a reconfigurable file. For example, the descriptive graph 22 may be coded in an XML (Extensible Markup Language) file. The redefinition of the descriptive graph 22 may come into play if the user downloads a new application which was not known during the proceeding implementation of the scheduling method 10 or if the user makes structural modifications to the audio architecture of the motor vehicle.

The invention thus provides a descriptive graph 22 controlled by the service 20 compared to a descriptive graph produced by the occurrence of the inputs/outputs. The invention effectively reduces and controls delays, thus improving the responsiveness of the system and enabling compliance with the responsiveness standards imposed by certain countries, including France. Some segments of the graph may benefit from minimal delays due to their priority over other segments. The invention also reduces the development time and installation time of audio systems. The audio architecture of the vehicle is then more flexible in terms of structural modification and updating. The scheduling being cyclical (n*Tm), the system returns at the end of a cycle to the same state as the initial state for all the inputs/outputs and for all the elementary functions 32. Thus, by ensuring that the scheduling causes no blockage in the scheduling of a cycle, it is possible to ensure that a blockage will never occur and to obtain a real-time system. Furthermore, the operating system 12 may comprise a means for anticipated starting of the service 20 during the starting of the operating system 12, similarly improving the responsiveness of the audio system.

1-7. (canceled)

8. A method for scheduling an audio processing of a motor vehicle, comprising the steps of:
wherein the audio processing comprises a plurality of elementary functions implemented by a microprocessor, each elementary function comprises at least one input or at least one output and a sample rate generated by a master clock, and a plurality of inputs and outputs, each input and each output comprising a frame size and the sample rate generated by the master clock;
grouping the elementary functions, the master clocks of which are synchronous, into synchronicity domains;
calculating a maximum processing time corresponding to a time required to process all frames of the inputs by means of the elementary functions when the inputs and outputs are produced sequentially, and, to return the elementary functions to their initial states; and
determining a scheduling of the elementary functions of each synchronicity domain as a function of the maximum processing time.

9. The scheduling method as claimed in claim 8, further comprising a step of interconnecting the synchronicity domains via asynchronous sample-rate converters.

10. The scheduling method as claimed in claim 8, further comprising a step of storing only the scheduling of the inputs and outputs.

11. The scheduling method as claimed in claim 10, further comprising a step of storing a descriptive graph a reconfigurable file.

12. An operating system comprising a framework configured to:
group elementary functions, master clocks of which are synchronous, into synchronicity domains, the elementary functions of an audio processing are implemented by a microprocessor, each elementary function comprises at least one input or at least one output and a sample rate generated by a master clock, and a plurality of inputs and outputs, each input and each output comprising a frame size and the sample rate generated by the master clock;
calculate a maximum processing time corresponding to a time required to process all frames of the inputs by means of the elementary functions when the inputs and outputs are produced sequentially, and, to return the elementary functions to their initial states; and
determine a scheduling of the elementary functions of each synchronicity domain as a function of the maximum processing time.

13. The operating system as claimed in claim 13, further comprising:
a file containing a descriptive graph of the scheduling of the elementary functions;
a service to interpret the descriptive graph as a function of the inputs and outputs; and
structural components controlled by the service and configured to perform audio processing operations.

14. The system as claimed in claim 13, wherein the service is initiated during an initiation of the operating system.
